(19) United States
(12) Patent Application Publication
(10) Pub. No.: US 2018/0050488 A1
(43) Pub. Date: Feb. 22, 2018

(54) SHAPING DEVICE AND SHAPING METHOD

(71) Applicant: MIMAKI ENGINEERING CO., LTD., Nagano (JP)

(72) Inventors: Masakatsu OKAWA, Nagano (JP); Kazuhiro OCHI, Nagano (JP)

(73) Assignee: MIMAKI ENGINEERING CO., LTD., Nagano (JP)

(21) Appl. No.: 15/673,427

(22) Filed: Aug. 10, 2017

(30) Foreign Application Priority Data
Aug. 17, 2016 (JP) 2016-159874

(51) Int. Cl. B29C 64/112; B29C 64/209; B29C 64/393; B33Y 10/00; B33Y 30/00; B33Y 40/00; B33Y 50/02

(52) U.S. Cl. CPC B29C 64/112; B29C 64/209; B29C 64/393; B33Y 50/02; B33Y 30/00; B33Y 40/00; B33Y 10/00

(57) ABSTRACT

A shaping device that shapes a three-dimensional (3D) object includes discharging heads and a controller; where the discharging heads include at least a black head that discharges a black material, and a coloring material head that discharges a material for coloring of a chromatic color; the controller causes the discharging heads to form a coloring region colored using at least the material for coloring, and a black region colored in black using at least the black material in at least one part of a portion where a hue is externally identifiable in the 3D object; and form the black region to be thicker than the coloring region with respect to a thickness in a normal direction perpendicular to a surface of the 3D object.

### CROSS REFERENCE TO RELATED APPLICATIONS

This application claims the priority benefit of Japanese Patent Application No. 2016-159874, filed on Aug. 17, 2016. The entirety of the above-mentioned patent application is hereby incorporated by reference herein and made a part of this specification.

### TECHNICAL FIELD

The present disclosure relates to a shaping device and a shaping method.

### DESCRIPTION OF THE BACKGROUND ART

A shaping device (three-dimensional printer (3D printer)) that shapes a three-dimensional object (3D object) using an ink jet head is conventionally known (see e.g., Japanese Laid-Open Patent Publication No. 2015-71282).

In such a shaping device, for example, the 3D object is shaped through the layering and shaping method by, for example, layering a plurality of layers of ink with the ink jet head.

### SUMMARY

A case of coloring the 3D object includes, for example, a case of coloring some region in black using a black ink. In such a case, for example, it is sometimes desired to represent deep black such as piano black, and the like for the way black is externally seen. Thus, a configuration that can more appropriately represent such deep black is conventionally desired. The present disclosure thus provides a shaping device and a shaping method that can solve the problem described above.

When carrying out shaping using the ink jet head, consideration is made to shaping a colored 3D object by further using an ink for coloring of a chromatic color in addition to black ink and carrying out the shaping. In this case, for example, coloring of various colors can be carried out by forming a region of a surface where hue can be visually recognized from the outside with the ink for coloring, and the like.

Furthermore, in such a case, for example, in order to represent various colors through the subtractive color mixing method, a coloring region formed with the ink for coloring is normally formed to a thickness that can transmit light in a normal direction with respect to a surface of the 3D object. Thus, for example, the light that entered from the outside of the 3D object through the coloring region is reflected at a region having light reflecting property on the inside to represent various colors. In the case of the conventional configuration, the region to be colored in black is also usually formed similar to the region to be colored in other colors.

It is desired that the black region sufficiently absorbs the light that entered from the outside rather than transmitting the light, as opposed to the region colored in other colors. To this end, consideration is made to using a dark black ink having high pigment density, for example, for the black ink used to form the black region so as to sufficiently absorb the light even if the thickness of the black region is small.

However, when forming the black region with the dark black ink, an impression as if only the surface is colored in black is given, and a deep black may become difficult to represent. More specifically, for example, when attempting to represent piano black, and the like, which is a shiny deep black, an impression that the deepness of the black is insufficient is given, and a high-class piano black, and the like may not be sufficiently represented.

On the contrary, the inventor of the present disclosure found, through thorough research, that the thickness of the black region is important in representing a deep black. Based on such knowledge, consideration is made to further thicken the black region with respect to the thickness in the normal direction rather than forming the black region same as the region of other colors. In such a case, for example, it was found that the deep black can be more appropriately represented by increasing the transmittance of the black region with respect to a unit thickness to a certain extent. Furthermore, the inventor of the present disclosure, through thorough researches, found the features necessary for obtaining such effects, and contrived the present disclosure.

In other words, in order to solve the problem described above, the present disclosure provides a shaping device that shapes a three-dimensional 3D object, the shaping device including a plurality of discharging heads that each discharges a material of shaping; and a controller that controls the operation of the discharging head; wherein the plurality of discharging heads include at least a black head that discharges a black material, and a coloring material head that discharges a material for coloring of a chromatic color; the controller causes the plurality of discharging heads to form a coloring region colored using at least the material for coloring, and a black region colored in black using at least the black material in at least one part of a portion where hue is externally identifiable in the 3D object; and form the black region to be thicker than the coloring region with respect to a thickness in a normal direction perpendicular to a surface of the 3D object.

When configured in such manner, for example, the thickness of the black region in the normal direction can be appropriately and sufficiently ensured. Thus, for example, even if the depth of color per unit thickness in the black region can be suppressed to a certain extent and a light of a certain extent can be transmitted, the light can be sufficiently absorbed in the entire black region. Thus, according to such configuration, for example, a deep black can be more appropriately represented in the black region. Furthermore, in this case, for example, the coloring region can be appropriately formed to a thickness in a range where various colors can be appropriately represented through the subtractive color mixing method. Thus, according to such configuration, for example, various colors other than black can be appropriately represented.

In the relevant configuration, black merely needs to be, for example, substantially black according to the demanded accuracy of coloring. Furthermore, black is, for example, is a color of an achromatic color having light absorbing property. Furthermore, in such configuration, the discharging head is, for example, an ink jet head. Moreover, the material of shaping is, for example, ink.

The black region is, for example, a region where a portion of greater than or equal to a predetermined area in the surface is filled in black. Furthermore, the black region may be a region of one part specified by the user or the shaping data of the portion colored in black in the 3D object. Thus, when coloring one part of the coloring region in black, for example, such portion may be considered as one part of the coloring region rather than as the black region. Furthermore, with respect to the coloring region, when referring to being colored using the material for coloring, this includes, for example, being colored by further using the black material in addition to the material for coloring of a chromatic color.

Furthermore, in the 3D object, the light reflecting region is preferably formed using a material having light reflecting property (e.g., white ink) on the inner side of the coloring region (interior side of 3D object). In this case, the inner side is the side close to the interior of the 3D object (interior side of the 3D object). According to such configuration, for example, the color representation by the subtractive color mixing method can be appropriately carried out. Furthermore, in this case, consideration is made not to form the light reflecting region on the inner side of the black region. Moreover, for example, the light reflecting region, which is thin compared to the inner side of the coloring region, may be formed on the inner side of the black region.

Consideration is also made to using a shaping method, and the like having a feature similar to the above for the configuration of the present disclosure. In this case as well, for example, effects similar to the above can be obtained. Furthermore, the shaping method can also be considered as, for example, a method for manufacturing the 3D object. Moreover, a configuration of a 3D object shaped with the shaping device or the shaping method can be considered for the configuration of the present disclosure.

### EFFECTS OF THE DISCLOSURE

According to the present disclosure, for example, a deep black can be more appropriately represented in the shaping device that shapes the 3D object.

### BRIEF DESCRIPTION OF THE DRAWINGS

FIGS. 1A and 1B are views showing one example of a shaping device 10 according to one embodiment of the present disclosure. FIG. 1A shows one example of a configuration of a main part of the shaping device 10. FIG. 1B shows one example of a configuration of a head unit 12 of the shaping device 10.

FIGS. 2A to 2C are views showing one example of a configuration of a 3D object 50 shaped by the shaping device 10. FIG. 2A is a cross-sectional view of one example of the configuration of the 3D object 50. FIG. 2B is a view describing features, and the like of a black region 308 in further detail. FIG. 2C is a view describing transmittance of the black region 308 in further detail.

FIGS. 3A to 3C are views describing the features of the 3D object 50 in further detail. FIG. 3A shows another example of a configuration of the 3D object 50 shaped by the shaping device 10. FIG. 3B shows a variant of the configuration of the 3D object 50. FIG. 3C shows a further variant of the configuration of the 3D object 50.

FIGS. 4A and 4B are views describing a further variant of the configuration of the 3D object 50. FIG. 4A shows one example of a configuration of when having the interior color of the 3D object 50 to be a color having light absorbing property. FIG. 4B shows a further variant of the configuration of the 3D object 50.

### DETAILED DESCRIPTION OF EMBODIMENTS

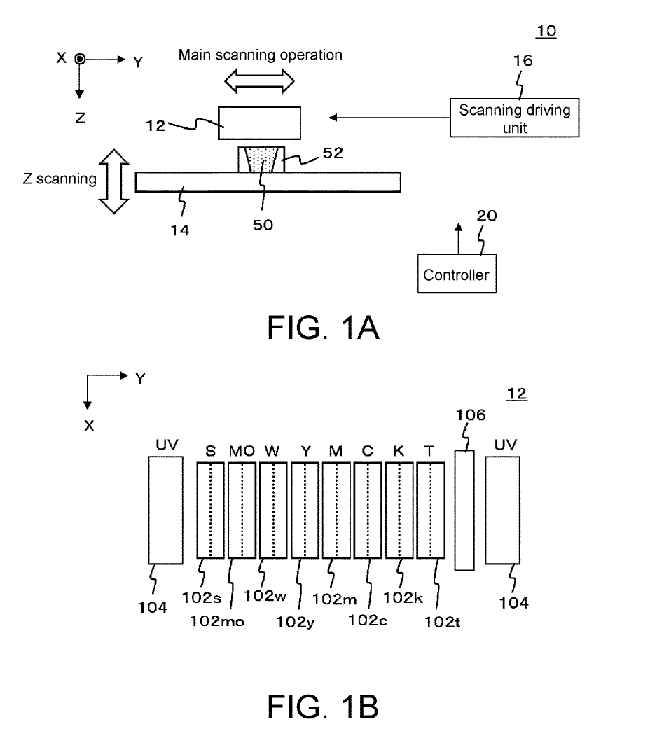

Hereinafter, an embodiment according to the present disclosure will be described with reference to the drawings. FIGS. 1A and 1B show one example of a shaping device 10 according to one embodiment. FIG. 1A shows one example of a configuration of a main part of the shaping device 10. FIG. 1B shows one example of a configuration of a head unit 12 of the shaping device 10.

Excluding the points described below, the shaping device 10 may have a configuration same as or similar to a known shaping device. More specifically, excluding the points described below, the shaping device 10 may have a configuration same as or similar to, for example, a known shaping device that carries out shaping by discharging a liquid droplet to become a material of a 3D object 50 using an ink jet head. Other than the illustrated configuration, for example, the shaping device 10 may also include various types of configurations necessary for shaping, coloring, and the like of the 3D object 50.

In the present example, the shaping device 10 is a shaping device (3D shaping device) that shapes a three-dimensional 3D object 50 through a layering and shaping method. In this case, the layering and shaping method is, for example, a method for shaping the 3D object 50 by overlapping a plurality of layers. In the present example, the shaping device 10 includes a head unit 12, a shaping table 14, a scanning driving unit 16, and a controller 20.

The head unit 12 is a portion that discharges the material of the 3D object 50. In this case, discharging the material of the 3D object 50 refers to, for example, discharging an ink to become the material of the 3D object 50. The ink is, for example, a liquid discharged from the ink jet head. The ink jet head is, for example, a discharging head that discharges the liquid droplet of ink (ink droplet) through an ink jet method.

More specifically, the head unit 12 discharges a liquid droplet of an ink that cures according to a predetermined condition from a plurality of ink jet heads, as the liquid droplet to become the material of the 3D object 50. The landed ink is then cured to form, in an overlapping manner, each layer configuring the 3D object 50. Furthermore, in the present example, an ultraviolet curing type ink (UV ink) that cures from a liquid state when irradiated with an ultraviolet ray is used for the ink.

Furthermore, the head unit 12 further discharges the material of a support layer 52 in addition to the material of the 3D object 50. The shaping device 10 thus forms the support layer 52, as necessary, at a periphery of the 3D object 50. The support layer 52 is, for example, a layered structural object that supports the 3D object 50 by surrounding the outer periphery of the 3D object 50 being shaped. The support layer 52 is formed, as necessary, during the shaping of the 3D object 50, and removed after the shaping is completed. A more specific configuration of the head unit 12 will be described in detail layer.

The shaping table 14 is a table-shaped member that supports the 3D object 50 being shaped and is arranged at a position facing the ink jet head in the head unit 12, where the 3D object 50 being shaped is mounted on an upper surface thereof. Furthermore, in the present example, the shaping table 14 has a configuration in which at least the upper surface is movable in a layering direction (Z direction in the figure), where at least the upper surface moves in accordance with the progress in the shaping of the 3D object 50 by being driven by the scanning driving unit 16. In this case, the layer direction is, for example, a direction in which the material of shaping is layered in the layering and shaping method. More specifically, in the present example, the layering direction is a direction (Z direction in the figure) orthogonal to a main scanning direction (Y direction in the figure) and a sub-scanning direction (X direction in the figure).

The scanning driving unit 16 is a driving unit that causes the head unit 12 to carry out a scanning operation of relatively moving with respect to the 3D object 50 being shaped. In this case, relatively moving with respect to the 3D object 50 being shaped means, for example, relatively moving with respect to the shaping table 14. Furthermore, in the present example, the scanning driving unit 16 causes the head unit 12 to carry out a main scanning operation (Y scanning), a sub-scanning operation (X scanning), and a layering direction scanning (Z scanning).

When referring to causing the head unit 12 to carry out the main scanning operation, this means, for example, causing the ink jet head of the head unit 12 to carry out the main scanning operation. Furthermore, the main scanning operation is, for example, an operation of discharging the ink while moving in the main scanning direction. In the present example, the scanning driving unit 16 causes the head unit 12 to carry out the main scanning operation by fixing the position of the shaping table 14 in the main scanning direction and moving the head unit 12 side. In a variant of the configuration of the shaping device 10, for example, the 3D object 50 side may be moved by fixing the position of the head unit 12 in the main scanning direction and, for example, moving the shaping table 14.

As will be described in detail below, the head unit 12 further includes an ultraviolet light source in the present example. At the time of the main scanning operation, the scanning driving unit 16 further carries out the drive of the ultraviolet light source in the head unit 12. More specifically, the scanning driving unit 16, for example, turns ON the ultraviolet light source at the time of the main scanning operation to cure the ink landed on a surface-to-be-shaped of the 3D object 50. The surface-to-be-shaped of the 3D object 50 refers to, for example, a surface on which a next layer of ink is formed by the head unit 12.

When referring to causing the head unit 12 to carry out the sub-scanning operation, this means, for example, causing the ink jet head of the head unit 12 to carry out the sub-scanning operation. The sub-scanning operation is, for example, an operation of relatively moving with respect to the shaping table 14 in the sub-scanning direction orthogonal to the main scanning direction. The sub-scanning operation may be an operation of relatively moving with respect to the shaping table 14 in the sub-scanning direction by a feeding amount set in advance.

Furthermore, in the present example, the scanning driving unit 16 causes the head unit 12 to carry out the sub-scanning operation between the main scanning operations. In this case, the scanning driving unit 16 causes the head unit 12 to carry out the sub-scanning operation by fixing the position of the head unit 12 in the sub-scanning direction and moving the shaping table 14. Furthermore, the scanning driving unit 16 may cause the head unit 12 to carry out the sub-scanning operation by fixing the position of the shaping table 14 in the sub-scanning direction and moving the head unit 12. The scanning driving unit 16 causes the head unit 12 to carry out the sub-scanning operation, only when necessary, according to the size of the 3D object 50 to shape. Thus, when shaping the 3D object 50 of a small size, and the like, the 3D object 50 may be shaped without carrying out the sub-scanning operation.

When referring to causing the head unit 12 to carry out the layering direction scanning, this means, for example, causing the ink jet head of the head unit 12 to carry out the layering direction scanning. Furthermore, the layering direction scanning is, for example, an operation of relatively moving the head unit 12 in the layering direction with respect to the 3D object 50 by moving at least one of the head unit 12 or the shaping table 14 in the layering direction. In this case, when referring to moving the head unit 12 in the layering direction, for example, this means moving at least the ink jet head in the head unit 12 in the layering direction. Furthermore, moving the shaping table 14 in the layering direction means, for example, moving the position of at least the upper surface in the shaping table 14.

The scanning driving unit 16 changes a head-table distance, which is a distance between the ink jet head in the head unit 12 and the shaping table 14, by causing the head unit 12 to carry out the layering direction scanning in accordance with the progress of the shaping operation. The head-table distance may be, for example, a distance between a nozzle surface, where a nozzle (nozzle hole) is formed in the ink jet head, and the upper surface of the shaping table 14. More specifically, in the present example, the scanning driving unit 16 fixes the position of the head unit 12 in the layering direction, and moves the shaping table 14. The scanning driving unit 16 may fix the position of the shaping table 14 in the layering direction, and move the head unit 12.

The controller 20 is, for example, a CPU of the shaping device 10, and controls each unit of the shaping device 10 to control the shaping operation of the 3D object 50. The controller 20 preferably controls each unit of the shaping device 10 based on, for example, shape information, color image information, and the like of the 3D object 50 to be shaped. According to the present example, the 3D object 50 can be appropriately shaped.

Next, a more specific configuration of the head unit 12 will be described. In the present example, the head unit 12 includes a plurality of ink jet heads. Each ink jet head is an example of a discharging head that respectively discharges the material of shaping, and the like, and includes a nozzle row in which a plurality of nozzles are lined in a predetermined nozzle row direction on a surface facing the shaping table 14. Furthermore, the shaping device 10 shapes the 3D object 50 by discharging the material from the plurality of nozzle rows in the head unit 12.

More specifically, in the present example, the head unit 12 includes a plurality of ink jet heads, a plurality of ultraviolet light sources 104, and a flattening roller 106. As shown in FIG. 1B, the plurality of ink jet heads include an ink jet head 102s, an ink jet head 102mo, an ink jet head 102w, an ink jet head 102y, an ink jet head 102m, an ink jet head 102c, an ink jet head 102k, and an ink jet head 102t. Such plurality of ink jet heads are, for example, arranged lined in the main scanning direction with the positions in the sub-scanning direction aligned.

The ink jet head 102s is an ink jet head (support layer head) that discharges the material (S) of the support layer 52. In the present example, an ultraviolet curing type ink, in which a cure degree by the ultraviolet ray is weaker than the material of the 3D object 50, is used for the material of the support layer 52. Thus, the ink jet head 102s discharges the ultraviolet curing type ink to become the material of the support layer 52 from each nozzle in the nozzle row.

As described above, the support layer 52, for example, supports the 3D object 50 by surrounding the outer periphery of the 3D object 50 being shaped. More specifically, for example, the support layer 52 supports an overhang shape of the 3D object from below to allow the shaping of the 3D object 50 including the overhang portion. Furthermore, for example, consideration is also made to discharging the material of the support layer 52 to a shaping area in the shaping table 14 and forming the support layer 52 to a plate shape, and the like before the start of the shaping operation. According to such configuration, for example, the bumps on the surface of the shaping table 14 are corrected, and the planarity can be more appropriately ensured. A water soluble material that can be dissolved in water after the shaping of the 3D object 50 is preferably used for the material of the support layer 52. In this case, a material of which cure degree is weaker and which more easily decomposes than the material configuring the 3D object 50 is preferably used. Furthermore, a known material for the support layer, for example, can be suitably used for the material of the support layer 52. According to such configuration, for example, the support layer 52 can be appropriately removed by dissolving, removing, and the like after the shaping is completed.

The ink jet head 102mo is an ink jet head that discharges a shaping material ink (MO ink), and discharges the shaping material ink from each nozzle in the nozzle row. In this case, the shaping material ink is, for example, a shaping dedicated ink used for the shaping of the interior (interior region) of the 3D object 50.

The interior of the 3D object 50 is not limited to being formed with the shaping material ink, and may be formed by further using an ink of another color. Furthermore, for example, consideration is also made to forming the interior of the 3D object 50 with only the ink of another color (e.g., white ink, etc.) without using the shaping material ink. In this case, the ink jet head 102mo may be omitted in the head unit 12.

The ink jet head 102w is an ink jet head that discharges a white (W) ink, and discharges the white ink from each nozzle in the nozzle row. In the present example, the white ink is an example of a material having light reflecting property, and is, for example, used when forming a region (light reflecting region) having a property of reflecting light in the 3D object 50. The light reflecting region, for example, reflects the light entering from outside the 3D object 50 when carrying out coloring in a full color representation by the subtractive color mixing method on the surface of the 3D object 50. The full color representation is, for example, a representation of color carried out with a possible combination of the subtractive color mixing by the inks of the process colors. In the present example, the ink jet head 102w is an example of a light reflective material head that discharges the material having light reflecting property.

The ink jet head 102y, the ink jet head 102m, the ink jet head 102c, and the ink jet head 102k (hereinafter referred to as ink jet heads 102y to 102k) are ink jet heads for decoration (decoration heads) used at the time of shaping of the colored 3D object 50, and respectively discharges the respective ink of a plurality of colors of ink (decoration ink) used for coloring from each nozzle in the nozzle row. More specifically, the ink jet head 102y discharges a yellow (Y) ink. The ink jet head 102m discharges a magenta (M) ink. The ink jet head 102c discharges a cyan (C) ink. The ink jet head 102k discharges a black (K) ink. In this case, each color of YMCK is an example of a process color used for the full color representation.

Furthermore, in the present example, the ink of each color of YMC is an example of a material for coloring of a chromatic color. The black (K) ink is an example of a black material. Among the ink jet heads for decoration, the ink jet head 102y, the ink jet head 102m, and the ink jet head 102c are examples of a coloring material head that discharges the material for coloring of a chromatic color. The ink jet head 102k is an example of a black head that discharges a black material. The ink jet head 102k is an example of a light absorbing material head that discharges a material having light absorbing property.

The ink jet head 102t is an ink jet head that discharges a clear ink, and discharges the clear ink from each nozzle in the nozzle row. The clear ink is, for example, an ink of a clear color or a colorless transparent color (T). In the present example, the clear ink is also an example of a material having translucency. The ink jet head 102t is an example of a translucent material head that discharges the material having translucency.

The plurality of ultraviolet light sources 104 are light sources (UV light sources) for curing the ink, and generate the ultraviolet ray for curing the ultraviolet curing type ink. Furthermore, in the present example, each of the plurality of ultraviolet light sources 104 is arranged at each of one end side and another end side in the main scanning direction in the head unit 12 so as to sandwich the arrangement of the ink jet heads in between. A UVLED (ultraviolet LED), and the like, for example, can be suitably used for the ultraviolet light source 104. Furthermore, consideration is also made to using a metal halide lamp, a mercury lamp, and the like for the ultraviolet light source 104.

The flattening roller 106 has a configuration for flattening the layer of ink formed during the shaping of the 3D object 50. At the time of the main scanning operation, for example, the flattening roller 106 comes into contact with the surface of the layer of ink and removes one part of the ink before being cured, to flatten the layer of ink.

The layer of ink configuring the 3D object 50 can be appropriately formed by using the head unit 12 having the configuration described above. Furthermore, the 3D object 50 can be appropriately shaped by forming the plurality of layers of ink in an overlapping manner.

A specific configuration of the head unit 12 is not limited to the configuration described above, and various modifications can be made. For example, in addition to the ink jet heads 102y to 102k, the head unit 12 may further include ink jet heads for colors such as a light color of each color, R (red), G (green), B (blue), orange, and the like for the ink jet heads for coloring. Furthermore, the manner of arranging the plurality of ink jet heads in the head unit 12 can also be variously modified. For example, the positions in the sub-scanning direction of some ink jet heads may be shifted from the other ink jet heads.

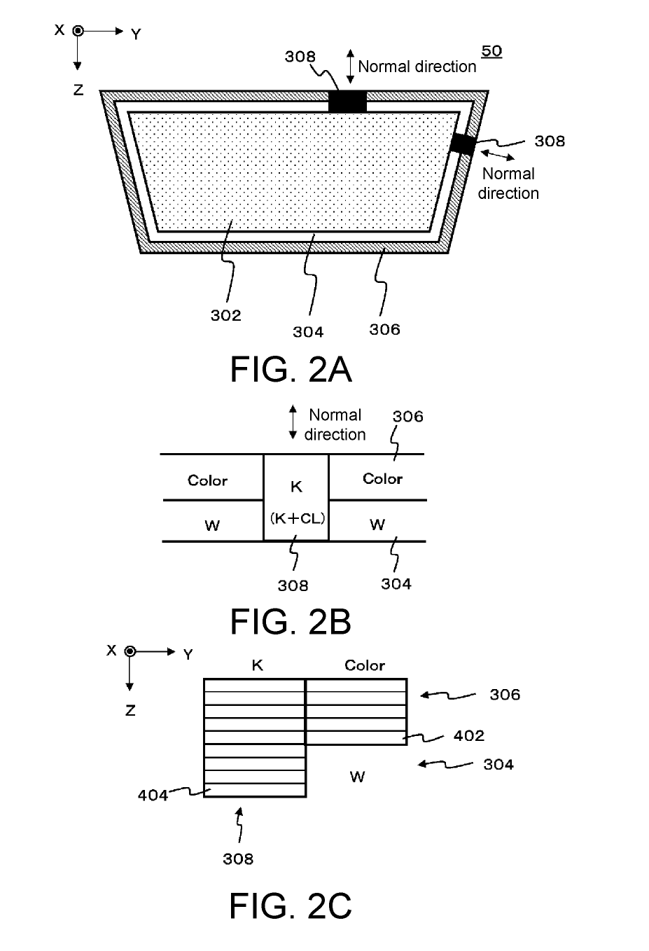

Next, a configuration of the 3D object 50 shaped by the shaping device 10 in the present example will be described. FIGS. 2A to 2C show one example of a configuration of the 3D object 50 shaped by the shaping device 10. FIG. 2A is a cross-sectional view of one example of the configuration of the 3D object 50, and shows one example of a cross-section of the 3D object 50 at a plane perpendicular to the sub-scanning direction (X direction) in a simplified manner.

Although the illustration is omitted, the shaping device 10 forms the support layer 52 (see FIGS. 1A and 1B) at the periphery of the 3D object 50, as necessary, at the time of shaping. For example, a cross-section at a plane perpendicular to the main scanning direction and the layering direction also has a region configuration similar to the case shown in FIG. 2A.

In the present example, the shaping device 10 can shape the 3D object 50 in which at least one part of a portion where hue can be externally identified is colored. Furthermore, when shaping such colored 3D object 50, for example, the shaping device 10 shapes the 3D object 50 including an interior region 302, a light reflecting region 304, a coloring region 306, and a black region 308, as in the illustrated configuration. In such a case, the controller 20 (see FIGS. 1A and 1B) of the shaping device 10 causes each ink jet head of the head unit 12 (see FIGS. 1A and 1B) to discharge various types of ink to form each region of the 3D object 50.

The interior region 302 is a region configuring the interior of the 3D object 50. The interior region 302 may, for example, be considered as a region configuring the shape of the 3D object 50. In the present example, the shaping device 10 forms the interior region 302 by, for example, forming the layer of shaping material ink discharged from the ink jet head 102mo (see FIGS. 1A and 1B) in an overlapping manner. Furthermore, the shaping device 10 may further use an ink other than the shaping material ink to form the interior region 302 by, for example, simultaneously using the ink jet head other than the ink jet head 102mo. Moreover, in the variant of the configuration of the shaping device 10, for example, consideration is also made to forming the interior region 302 with the white ink and the like discharged from the ink jet head 102w (see FIGS. 1A and 1B) without using the ink jet head 102mo. In this case, the interior region 302 and the light reflecting region 304 may not be distinguished, and a region combining both regions may be formed.

The light reflecting region 304 may be a region having light reflecting property fomied using the ink having light reflecting property. In the present example, the shaping device 10 forms the light reflecting region 304 by, for example, forming the layer of white ink discharged from the ink jet head 102w in an overlapping manner. In such a case, the shaping device 10 forms the light reflecting region 304 so as to surround the periphery of the interior region 302, as shown in the figure. More specifically, in the present example, the shaping device 10 forms the light reflecting region 304 with respect to a position other than the portion for forming the black region 308 in the outer side of the interior region 302. In this case, the outer side is the side close to the exterior of the 3D object 50 (exterior side of the 3D object 50). Furthermore, in this case, the coloring region 306 is further formed on the outer side of the light reflecting region 304. When configured in such manner, the full color representation with the subtractive color mixing method can be appropriately carried out as, for example, the light reflecting region 304 is formed on the inner side of the coloring region 306. The colored 3D object 50, for example, thus can be appropriately shaped.

The thickness of the light reflecting region 304 is preferably formed to an even thickness of, for example, about 100 μm to 1 mm. In this case, the thickness of the region is, for example, the thickness in a normal direction perpendicular to the surface of the 3D object 50. In the present example, the shaping device 10 forms the light reflecting region 304 using only the white ink. In a variant of the configuration of the shaping device 10, for example, when carrying out the shaping at a higher speed, consideration is also made to further using the clear ink other than the white ink to form the light reflecting region 304.

The coloring region 306 is a region where coloring is performed in the surface of the 3D object 50. In this case, the surface of the 3D object 50 is, for example, the portion where the hue can be externally identified in the 3D object 50. In the present example, the coloring region 306 is a region where colors other than black can be colored. Furthermore, the coloring region 306 is an example of a region colored using the material for coloring of a chromatic color.

Moreover, the shaping device 10 forms a layer of ink colored in a desired color using, for example, the ink of each color of YMCK discharged from the ink jet heads 102y to 102k (see FIGS. 1A and 1B) and the clear ink discharged from the ink jet head 102t (see FIGS. 1A and 1B). Such layers of ink are formed in an overlapping manner to form the coloring region 306.

When configured in such manner, for example, the amount of change in the usage amount of the YMCK ink caused by the difference in the color to represent can be compensated by using the clear ink in addition to the ink of each color of YMCK. Thus, for example, the respective layers of ink configuring the coloring region 306 can be appropriately formed to a constant thickness. Therefore, according to the present example, for example, the full color representation can be more appropriately carried out. The thickness of the coloring region 306 is preferably formed to an even thickness of, for example, about 50 μm to 500 μm (e.g., about 300 μm). The thickness of the coloring region 306 may, for example, be smaller than 250 μm. Furthermore, in order to more appropriately enhance the resolution of the image drawn by coloring, for example, the thickness is preferably made to be smaller than or equal to 150 μm.

In the present example, the shaping device 10 foil is the coloring region 306 with respect to the position other than the portion where the black region 308 is to be formed in the surface of the 3D object 50. Thus, the coloring region 306 is formed to cover the entire outer side of the light reflecting region 304. In a variant of the configuration of the shaping device 10, for example, the coloring region 306 may be formed on the outer side of one part of the light reflecting region 304.

The black region 308 is a region colored in black in the surface of the 3D object 50. In this case, when referring to the black region 308 being colored in black, this means for example, that the coloring is carried out so as to fill the region in black under a condition different from when one part of the coloring region 306 is colored in black. Thus, the black region 308 may, for example, be a region of one part specified by the user or the shaping data of the portion colored in black in the 3D object 50. Furthermore, the black region 308 is an example of a region colored in black using a black material. The black region 308 may, for example, be a region where a portion of greater than or equal to a predetermined area in the surface is filled in black.

Moreover, in the present example, black merely needs to be, for example, substantially black according to the demanded accuracy of coloring. More specifically, in the present example, the black region 308 is a region colored in piano black. In this case, the piano black is, for example, a shiny deep black. On the contrary, when more generally considered, black can be considered as, for example, an achromatic color having light absorbing property. Thus, the black region 308 can also be considered as a light absorbing region formed with a material having light absorbing property.

In the present example, for example, the shaping device 10 forms the black region 308 so as to be distinguished from the coloring region 306 by forming the black region 308 to a thickness different from the coloring region 306, as shown in the figure. More specifically, in the illustrated case, the shaping device 10 forms the black region 308 on the outer side of the region not formed with the light reflecting region 304 on the outer side of the interior region 302. In this case, the black region 308 is formed with the black (B) ink and the clear (CL) ink using the ink jet head 102t in addition to the ink jet head 102k (see FIGS. 1A and 1B). More specifically, in this case, the controller 20 causes the ink jet head 102k to discharge the black ink and causes the ink jet head 102t to discharge the clear ink to cause the ink jet head 102k and the ink jet head 102t to form the black region 308. According to such configuration, for example, the black region 308 can be formed with a lighter black compared to when the black region 308 is formed with only the black ink. In this case, when referring to forming the black region 308 with a lighter black, this means, for example, forming the black region 308 with black, of which transmittance with respect to a unit thickness becomes greater.

Furthermore, the shaping device 10 may further form the black region 308 thicker than the coloring region 306 with respect to the thickness in the normal direction. More specifically, in the illustrated case, the thickness of the black region 308 is equal to the thickness in which the light reflecting region 304 and the coloring region 306 are overlapped. According to such configuration, for example, the thick black region 308 can be appropriately formed while appropriately preventing a step difference from forming between the coloring region 306 and the black region 308 at the surface of the 3D object 50, and the like.

FIG. 2B is a view describing features, and the like of the black region 308 in further detail. As also described above, in the present example, the shaping device 10 forms the coloring region 306 and the black region 308 in at least one part of the surface of the 3D object 50. Furthermore, the black region 308 is formed thicker than the coloring region 306 with respect to the thickness in the normal direction. When configured in such manner, for example, the thickness of the black region 308 in the normal direction can be appropriately and sufficiently ensured. Thus, for example, even if the depth of color per unit thickness in the black region 308 is suppressed to a certain extent and a light of a certain extent can be transmitted, the light can be sufficiently absorbed in the entire black region 308. More specifically, in the present example, the black region 308 is formed by further using the clear ink in addition to the black ink, and hence the black region 308 is formed with a lighter black than when formed with only the black ink, as also described above.

When configured in such manner, for example, the light that entered from the outside can be reached farther back in the black region 308 compared to when the black region 308 is formed with a dark black. Furthermore, the light can be sufficiently absorbed by the entire black region 308 by making the thickness of the black region 308 sufficiently large. Thus, according to the present example, for example, the deep black can be more appropriately represented in the black region 308 compared to when the coloring of dark black is carried out and substantially all the light is absorbed by only a surface layer portion.

Considering only the representation of deep black, it appears that the black region 308 does not necessarily need to be made thicker than the coloring region 306, and the coloring region 306 merely needs to be formed thick similar to the black region 308. However, in the case of the coloring region 306, if the thickness in the normal direction is increased, for example, color dullness, and the like may occur, and the appearance after the coloring may lower. Thus, the coloring region 306 is not formed thicker than necessary, and for example, is preferably formed to a thickness suited for carrying out the full color coloring.

On the other hand, according to the present example, for example, the coloring region 306 can be appropriately formed to a thickness in a range where various colors can be appropriately represented through the subtractive color mixing method. Thus, for example, various colors other than black can also be more appropriately represented at a high accuracy.

More specifically, the thickness of the black region 308 in the normal direction is, for example, greater than or equal to 250 μm and preferably greater than or equal to 300 μm. Furthermore, a difference in thickness between the black region 308 and the black region 308 in the normal direction is, for example, preferably greater than or equal to 50 μm. Furthermore, such difference in thickness is more preferably greater than or equal to 100 μm.

Furthermore, as also described above, the black region 308 is formed using the black ink and the clear ink in the present example. In this case, for example, an ink containing a black pigment for a color material can be suitably used for the black ink. According to such configuration, for example, a dark black can be more appropriately represented when using the black ink alone for the coloring and the like in the coloring region 306. Furthermore, even the light black suited for the formation of the black region 308 can be appropriately represented by simultaneously using the clear ink.

Furthermore, as also described above, the clear ink is further used in addition to the ink of each color of CMYK when forming the coloring region 306 in the present example. More specifically, in this case, the controller 20 causes the ink jet heads 102y to 102k and the ink jet head 102t to discharge the respective inks to form the coloring region 306.

In such a case, in the present example, for example, the plurality of ink jet heads in the head unit 12 are caused to form the black region 308 and the coloring region 306 such that a content ratio of the clear ink in the black region 308 becomes greater than a content ratio of the clear ink in the coloring region 306. In this case, the content ratio of the clear ink in the region is, for example, the proportion occupied by the clear ink in the ink configuring the relevant region. The proportion occupied by the clear ink may be, for example, the proportion in weight ratio. According to such configuration, for example, the black region 308 can be appropriately formed with light black.

The content ratio of the clear ink in the black region 308 is preferably appropriately set according to the depth of the black ink used with the clear ink. Furthermore, in this case, the depth of the black ink differs, for example, according to the type of pigment to use, and the like. Thus, the difference in content ratio of the clear ink compared with the coloring region 306 may differ depending on the specific ink to use.

Furthermore, consideration is also made to making the content of the clear ink in the black region 308 smaller than in the coloring region 306 depending on the depth of the black ink to use. More specifically, for example, in a variant of the shaping device 10, consideration is also made to further using a dedicated ink jet head to use for the formation of the black region 308. In this case, for example, rather than using the same black ink for the coloring region 306 and the black region 308, a dedicated black ink is used to form the black region 308. In this case, consideration is made to using the black ink lighter than the normal black ink, used for the formation of the coloring region 306, for the formation of the black region 308. In such a case, for example, the content ratio of the clear ink in the black region 308 may be made smaller than in the coloring region 306, as described above. In this case, the black region 308 may be formed using only the black ink for the black region 308 without using the clear ink.

As described above as well, in the present example, the representation of deep black can be realized by forming the black region 308, of which entire thickness is sufficiently thick, using the light black ink. In this case, for example, the black region 308 is preferably formed such that the transmittance with respect to the portion of a predetermined thickness (e.g., unit thickness) becomes sufficiently large and the transmittance with respect to the entire black region 308 becomes sufficiently small.

FIG. 2C is a view describing the transmittance of the black region 308 in further detail, and shows one example of a state of the black region 308 at a position where the normal direction becomes parallel to the layering direction (Z direction) in a simplified manner along with the light reflecting region 304 and the coloring region 306 at the periphery. As also described above, in the present example, the shaping device 10 shapes the 3D object 50 through the layering and shaping method. In this case, the layer of ink corresponding to each piece of slice data is formed in an overlapping manner based on a plurality of pieces of slice data corresponding to the cross-section of each position of the 3D object 50 to shape the 3D object 50.

For example, in the present example, the shaping device 10 forms the black region 308 by overlapping a layer 404 of ink formed with the black ink and the clear ink. In this case, each layer 404 to be layered may be a layer colored in black of the same depth. Furthermore, the coloring region 306 is formed by overlapping a layer 402 of ink formed with the ink of each color of YMCK and the clear ink. In this case, the layer 402 and the layer 404 are regions in one layer of ink formed in correspondence with one piece of slice data.

In this case, with respect to the transmittance of the black region 308, the transmittance of one layer 404 and the transmittance of the entire black region 308 are preferably set to an appropriate range, respectively. More specifically, in the black region 308, the transmittance with respect to one layer 404, which is a region for one layer, formed in correspondence with one piece of slice data is preferably greater than or equal to 40%. In this case, the transmittance with respect to one layer 404 is the transmittance of light in the layering direction. The transmittance may be, for example, a transmittance of white natural light. Furthermore, the transmittance with respect to one layer 404 is preferably greater than or equal to 65%.

Furthermore, the transmittance of the entire black region 308 is preferably smaller than or equal to 10%. In this case, the transmittance of the entire black region 308 refers to the transmittance of the black region 308 in the normal direction. Moreover, the transmittance of the entire black region 308 is preferably smaller than or equal to 5%, and more preferably smaller than or equal to 1%. According to such configuration, for example, a deep black can be appropriately represented with a configuration of layering the layer 404 of ink, of which density is low with only one layer.

In FIG. 2C, a state of the black region 308, and the like at the position where the normal direction becomes parallel to the layering direction is shown. Thus, in this case, the transmittance of the entire black region 308 becomes the transmittance in the layering direction. In this case, a great number of layers 404 needs to be formed in an overlapping manner, as shown in the illustrated configuration, to make the transmittance of the entire black region 308 sufficiently small. Furthermore, in the present example, a greater number of layers 404 can be layered by making the thickness of the black region 308 in the normal direction thicker than the coloring region 306. Thus, according to the present example, for example, the transmittance of the entire black region 308 can be appropriately adjusted using the layer 404 of ink, of which density is low with only one layer.

Furthermore, in the 3D object 50, for example, the black region 308 is sometimes formed at a position where the normal direction does not become parallel to the layering direction. In such a case as well, the transmittance with respect to the unit thickness can be appropriately enhanced by forming the black region 308 using the layer 404 of ink, of which density is low with only one layer. Furthermore, the transmittance of the entire black region 308 can be appropriately adjusted by making the thickness of the black region 308 in the normal direction sufficiently thick. Thus, according to such configuration, for example, a deep black can be appropriately represented even in the black region 308 at the position where the normal direction does not become parallel to the layering direction.

In order to more appropriately represent a deep black, the absorptance and the like of light in the black region 308 also needs to be appropriately set, in addition to the transmittance of the black region 308. More specifically, the absorptance of light in the entire black region 308 is preferably made sufficiently large to appropriately represent black according to the demanded accuracy, and the like of the color. On the contrary, in the present example, the absorptance of light in the entire black region 308 can be appropriately enhanced by overlapping a great number of layers 404 of ink having low density to form the black region 308.

Furthermore, the way the black represented by the black region 308 is seen changes, for example, depending on whether shiny or not, as well. The shininess of the color is greatly influenced by, for example, the state of the surface of the 3D object 50. Thus, for example, when representing shiny black such as piano black, and the like, the surface of the 3D object 50 in the region where at least the black region 308 is formed is preferably formed in a glossy smooth state. Furthermore, a matted black, and the like is sometimes desirably represented, other than the shiny black such as the piano black, for the deep black. In such a case, the surface of the 3D object 50 is considered to be formed in the matted state.

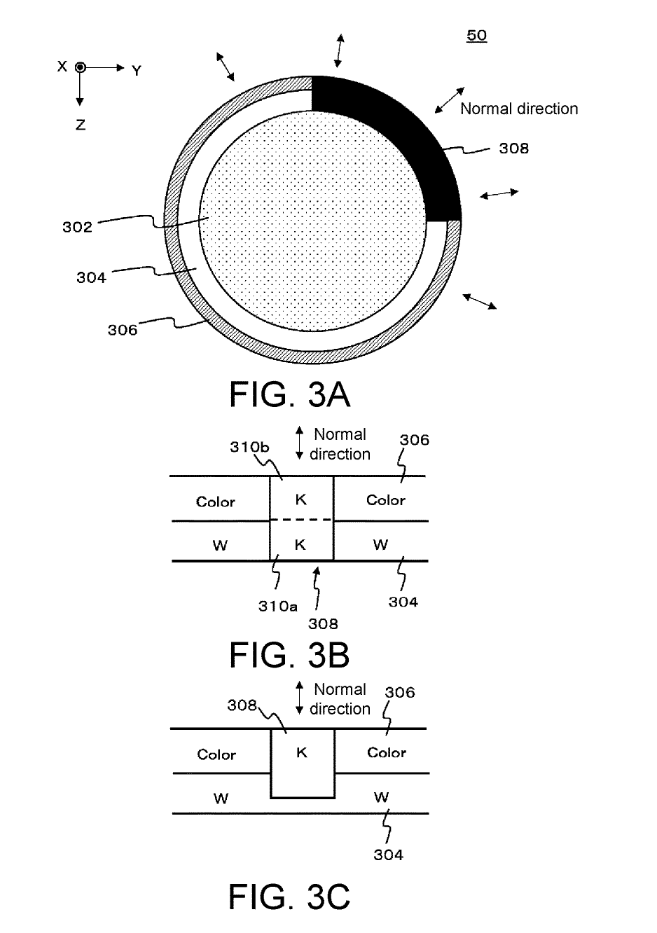

Next, supplementary explanation, description of a variant, and the like will be made for a feature of the 3D object 50 shaped in the present example. FIGS. 3A to 3C are views describing a feature of the 3D object 50 in further detail. Excluding the points described below, the configuration denoted with the same reference numeral as FIGS. 1A to 2C in FIGS. 3A to 3C may have a feature same as or similar to the configuration in FIGS. 1A to 2C.

FIG. 3A shows another example of a configuration of the 3D object 50 shaped by the shaping device 10. In FIG. 2A, the 3D object 50 in which the outer peripheral surface has a planar shape is illustrated for the sake of convenience of illustration and explanation. In this case, the normal direction of the 3D object 50 is a direction perpendicular to the plane configuring the outer peripheral surface.

However, the shaping device 10 is not limited to shaping the 3D object 50 in which the outer peripheral surface has a planar shape, and may shape the 3D object 50 of various shapes. For example, in FIG. 3A, one example of a configuration is illustrated for the 3D object 50 having a spherical shape. In such a case, the outer peripheral surface of the 3D object 50 is a curved surface. Furthermore, the normal direction of the 3D object 50 is a direction orthogonal to the surface at each position of the 3D object 50, as shown with an arrow in the figure. In this case as well, the deep black can be appropriately represented by forming the black region 308 of light black with a sufficient thickness.

The direction orthogonal to the surface at each position of the 3D object 50 is, for example, the direction orthogonal to a tangent plane at each position. Furthermore, in this case, the normal direction may be the direction assumed as substantially the normal direction according to the accuracy, and the like demanded on shaping.

Furthermore, in a variant of a shaping operation of the shaping device 10, consideration is made to further forming a region other than each region described above for the region configuring the 3D object 50, and the like. More specifically, for example, consideration is made to forming a separation region between the light reflecting region 304 and the coloring region 306, and the like. In this case, the separation region is, for example, a transparent region formed with the clear ink, and prevents the white ink configuring the light reflecting region 304 from mixing with the ink of each color configuring the coloring region 306.

Furthermore, for example, consideration is made to further forming a transparent protective region on the outer side of the coloring region 306 and the black region 308, and the like. In this case, the protective region is, for example, a transparent region formed with the clear ink, and protects the coloring region 306 and the black region 308 by covering the outer side of the coloring region 306 and the black region 308.

In this case, a deeper impression can be provided, and the like for the black represented with the black region 308 by forming the transparent region that covers the outer side of the black region 308. Furthermore, for example, the shiny black such as the piano black can be more appropriately represented by forming the surface of the protective region in a glossy smooth state.

Furthermore, consideration is made to forming the transparent region that covers the outer side of the black region 308 with a method (clear coat) such as painting, for example, rather than forming the relevant region at the time of shaping with the shaping device 10. In this case, for example, consideration is made to having the surface of the 3D object 50 in a matted state at the time of shaping with the shaping device 10, and carrying out glossy painting (gloss painting) with a transparent material with respect to the relevant surface. When configured in such manner as well, shininess can be provided to the black region 308 to appropriately represent the shiny black such as the piano black.

It is sometimes desired to have the surface to be a matted form depending on the quality demanded on the 3D object 50. In such a case, for example, consideration is made to carrying out a matted painting (mat painting) by a transparent material with respect to the surface of the 3D object 50. When configured in such manner as well, the 3D object 50 of desired quality can be appropriately shaped. In this case, for example, the surface of the 3D object 50 may be in a glossy state at the time of shaping with the shaping device 10, which is a state before carrying out the mat painting.

In the description made above, a configuration of when uniformly coloring by overlapping a layer of ink having the same depth, and the like have been mainly described for the configuration of the black region 308. However, the depth of black in the black region 308 is not necessarily uniform, and for example, may be differed according to the position in the normal direction.

FIG. 3B shows a variant of the configuration of the 3D object 50. In this case, the shaping device 10 forms the black region 308 divided into a plurality of regions 310a, 310b in the layering direction. The regions 310a, 310b are, for example, regions respectively colored to black of different depth by differing the content ratio of the clear ink. When configured in such manner as well, the deep black can be appropriately represented by forming the black region 308 in light black with a sufficient thickness.

Furthermore, in this case, the density of black in the region 310b on the outer side is preferably a density lighter than the region 310a on the inner side. According to such configuration, the deep black can be more appropriately represented. Furthermore, the number of regions to divide the black region 308 may be more. In this case, for example, the depth of black of the plurality of regions may be changed in a gradation form, for example, such that the density of black in the region on the outer side in the 3D object 50 becomes lighter than the region on the inner side. Furthermore, in this case, for example, one or a plurality of regions on the outermost side may be a colorless transparent region formed with the clear ink.

In the description made above, a configuration of when forming the light reflecting region 304 only on the inner side of the coloring region 306 without forming the light reflecting region 304 on the inner side of the black region 308, and the like have been mainly described. However, in a further variant of the configuration of the 3D object 50, the light reflecting region 304 may also be formed on the inner side of the black region 308.

FIG. 3C is a view showing a further variant of the configuration of the 3D object 50, and shows one example of a configuration of the 3D object 50 of when the light reflecting region 304 is also formed on the inner side of the black region 308. In this case, the shaping device 10 differs the thickness of the light reflecting region 304 between the inner side of the coloring region 306 and the inner side of the black region 308 according to the difference in thickness of the coloring region 306 and the black region 308 with respect to the thickness in the normal direction. In this case, the controller 20 (see FIGS. 1A and 1B) causes the plurality of ink jet heads in the head unit 12 to form the coloring region 306 and the black region 308 on the outer side of at least one part of the light reflecting region 304. The thickness of the portion overlapping the black region 308 in the normal direction is made smaller than the thickness of the portion overlapping the coloring region 306 in the normal direction with respect to the thickness of the light reflecting region 304 in the normal direction. More specifically, in this case, the thickness of the black region 308 and the light reflecting region 304 combined is preferably adjusted so as to be equal to the thickness of the coloring region 306 and the light reflecting region 304 combined, as in the illustrated configuration.

According to such configuration, for example, the coloring region 306 and the black region 308, of which thicknesses in the normal direction differ, can be appropriately formed on the outer side of the light reflecting region 304. Thus, for example, the deep black can be more appropriately represented.

Furthermore, in the description made above, a case of forming the black region 308 using the black ink used as one of the process colors used for color representation has been mainly described above. However, in a variant of the configuration of the shaping device 10, a light black ink to use for the formation of the black region 308 may be further used apart from the black ink of the process color, as briefly described above in relation to FIGS. 2A to 2C. In this case, the head unit 12 further includes an ink jet head that discharges a black ink lighter than the black for the process color. In this case, the light black can be represented without simultaneously using the clear ink, and hence the layer of ink configuring the black region 308 may be formed with only such light black ink without using the clear ink.

Furthermore, for example, consideration is made to using an ink containing a black dye for a color material, and the like for the light black ink. When configured in such manner as well, the deep black can be appropriately represented by forming the black region 308 in light black with a sufficient thickness.

When considering the feature of the present example in a more generalized manner, consideration is also made to representing a deep color for not only black but also for other colors having light absorbing property according to the configuration similar to the present example. In this case, the color having light absorbing property is, for example, colors such as a color obtained by mixing one of the chromatic colors and black, a dark gray, and the like. Furthermore, the light having light absorbing property may be a color of low intensity. Even in such a case, a deep color can be represented by forming a region corresponding to the black region 308 using other colors having light absorbing property in place of black.

Furthermore, in order to more appropriately represent a deep dark black in the black region 308 and the like, for example, it is sometimes preferable to also consider the color of the interior of the 3D object 50. More specifically, for example, when shaping the 3D object 50 of a small size or when forming the 3D object 50 including a thin portion, the light entering from the back side of the 3D object 50 with respect to a line of sight of observing the 3D object 50 may be transmitted through the 3D object 50 thus influencing the way the color of the 3D object 50 is seen. Thus, in a further variant of the configuration of the 3D object 50, consideration is also made to using a configuration that can more appropriately suppress the influence of the transmitted light, and the like.

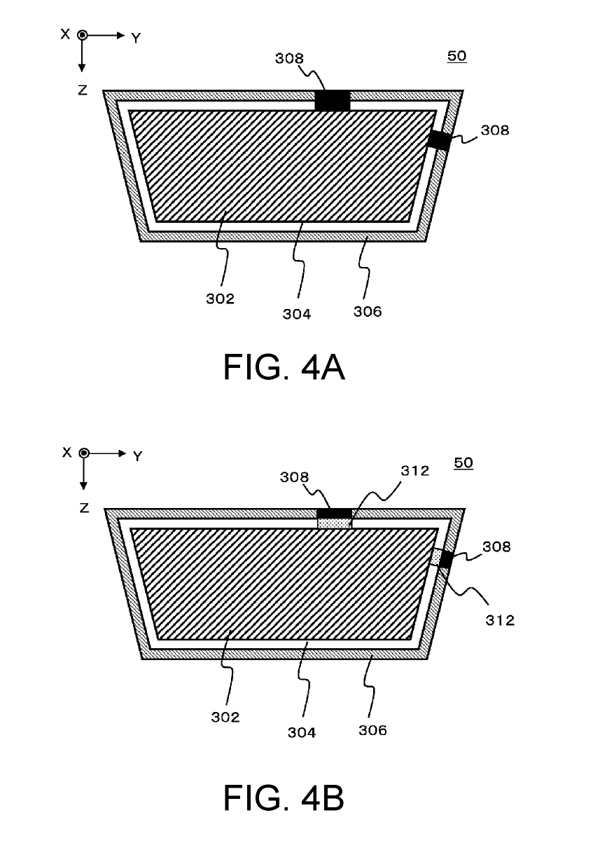

FIGS. 4A and 4B are views describing a further variant of the configuration of the 3D object 50, and shows an example of a configuration when having the color of the interior of the 3D object 50 as a color having light absorbing property. Excluding the points described below, the configuration denoted with the same reference numeral as FIGS. 1A to 3C in FIGS. 4A and 4B may have a feature same as or similar to the configuration in FIGS. 1A to 3C.

FIG. 4A is a view showing one example of a configuration of when having the color of the interior of the 3D object 50 as a color having light absorbing property, and shows one example of the configuration of the 3D object 50 for when forming the black region 308 same as or similar to the case described using FIGS. 1A to 3C. In this case, the controller 20 (see FIGS. 1A and 1B) causes the plurality of ink jet heads in the head unit 12 (see FIGS. 1A and 1B) to form the interior region 302 with the color having light absorbing property. The coloring region 306 and the black region 308 are then formed on the outer side of the interior region 302. The 3D object 50 is thereby shaped with a configuration (wrapping method) as if wrapping a black bean paste inside.

When configured in such manner, for example, the influence of the light passing through the interior of the 3D object 50 and exiting to the opposite side can be appropriately suppressed by forming the interior region 302 with the color having light absorbing property. Thus, for example, the deep dark black can be more appropriately represented in the black region 308. Furthermore, in this case, the influence of the color, and the like on the back surface side of the 3D object 50 can be appropriately suppressed even for the coloring region 306. Thus, various colors can be more appropriately represented even for the coloring region 306.

In the relevant configuration, the interior region 302 is preferably formed in black, for example. According to such configuration, for example, the interior region 302 having light absorbing property can be appropriately formed. In this case, for example, consideration can be made to forming the interior region 302 using the ink jet head 102k (see FIGS. 1A and 1B) for the black ink. Furthermore, the color of the interior region 302, for example, may be colored to a substantial black represented with a mixed color of Y (yellow), M (magenta), and C (cyan) instead of the black colored with the black ink. In this case, for example, the interior region 302 is foiuied using the ink jet heads 102y to 102k (see FIGS. 1A and 1B) for each color of YMC. In this case, the ink jet head 102k, and the like may be further used to form the interior region 302. Furthermore, when using the ink jet head 102mo (see FIGS. 1A and 1B) for the shaping material ink, as in the head unit 12 described using FIGS. 1A and 1B and the like, consideration is also made to using the shaping material ink of a color having light absorbing property such as black.

According to such configuration, for example, the interior region 302 can be appropriately formed with the color having light absorbing property. Furthermore, the influence of the light passing through the interior of the 3D object 50 and exiting to the opposite side can be appropriately suppressed. In this case as well, it is preferable not to form the light reflecting region 304 on the inner side of the black region 308. According to such configuration, the deep black can be more appropriately formed. In this case as well, the light reflecting region 304 is preferably formed between the coloring region 306 and the interior region 302. According to such configuration, for example, various colors can be more appropriately represented in the coloring region 306.

When attempting to represent a deep black by thickening the black region 308 in the normal direction, a region having light absorbing property such as black is preferably connected so as to be continuous from the inner side of the 3D object 50 toward the surface so that the interior region 302 and the black region 308 are adjacent, as shown in FIG. 4A. However, when focused on suppressing the influence of the light passing through the interior of the 3D object 50 and exiting to the opposite side, the configuration of the 3D object 50 may be further differed.

FIG. 4B shows a further variant of the configuration of the 3D object 50. In this case as well, the interior region 302 is formed with the color having light absorbing property, similar to the case shown in FIG. 4A. Furthermore, the light reflecting region 304 is not formed on the inner side of the black region 308. In this case as well, the light reflecting region 304 is formed between the coloring region 306 and the interior region 302.

In this case, the thickness of the black region 308 in the normal direction may be smaller than the thickness of the light reflecting region 304 and the coloring region 306 combined. For example, in FIG. 4B, a configuration of when the thickness of the black region 308 in the normal direction is made the same as the coloring region 306 is illustrated. A region 312 different from the black region 308 is further formed between the black region 308 and the interior region 302. In this case, for example, consideration is made to forming a transparent region formed with the clear ink, and the like for the region 312. When configured in such manner as well, the influence of the light passing through the interior of the 3D object 50 and exiting to the opposite side can be appropriately suppressed by forming the interior region 302 with the color having light absorbing property.

### INDUSTRIAL APPLICABILITY

The present disclosure can be suitably used for, for example, the shaping device.

What is claimed is:

1. A shaping device that shapes a three-dimensional object, the shaping device comprising:
a plurality of discharging heads that each discharges a material of shaping; and
a controller that controls operations of the plurality of discharging heads, wherein
the plurality of discharging heads include at least:
a black head that discharges a black material; and
a coloring material head that discharges a material for coloring of a chromatic color,
the controller causes the plurality of discharging heads to form
a coloring region colored using at least the material for coloring; and
a black region colored in black using at least the black material
in at least one part of a portion where a hue is externally identifiable in the three-dimensional object, and
form the black region to be thicker than the coloring region with respect to a thickness in a normal direction perpendicular to a surface of the three-dimensional object.

2. The shaping device according to claim 1, wherein a difference in thickness of the black region and the coloring region in the normal direction is greater than or equal to 50 μm.

3. The shaping device according to claim 1, further comprising a light reflecting material head that discharges a material having a light reflecting property for the discharging head; wherein the controller
forms a light reflecting region, which is a region having the light reflecting property, using at least the light reflecting material head,
forms the coloring region on an outer side of at least one part of the light reflecting region using at least the coloring material head; and
the black region is formed on an outer side of a region not formed with the light reflecting region using at least the black head.

4. The shaping device according to claim 1, further comprising a light reflecting material head that discharges a material having a light reflecting property for the discharging head; wherein the controller
forms a light reflecting region, which is a region having the light reflecting property, using at least the light reflecting material head,
causes the plurality of discharging heads to form the coloring region and the black region on an outer side of at least one part of the light reflecting region, and
makes a thickness of a portion overlapping the black region in the normal direction smaller than a thickness of a portion overlapping the coloring region in the normal direction with respect to a thickness of the light reflecting region in the normal direction.

5. The shaping device according to claim 1, further comprising a translucent material head that discharges a material having translucency for the discharging head; wherein the controller causes the black head to discharge the black material and the translucent material head to discharge the material having translucency to cause the black head and the translucent material head to form the black region.

6. The shaping device according to claim 5, wherein the controller
causes at least the coloring material head to discharge the coloring material and the translucent material head to discharge the material having translucency to form the coloring region using at least the coloring material head and the translucent material head; and
causes the plurality of discharging heads to form the black region and the coloring region such that a content ratio of the material having translucency in the black region becomes greater than a content ratio of the material having translucency in the coloring region.

7. The shaping device according to claim 1, wherein the black material is an ink containing a black pigment for a color material.

8. The shaping device according to claim 1, wherein the black material is an ink containing a black dye for a color material.

9. The shaping device according to claim 1, wherein
the three-dimensional object is shaped through a layering and shaping method based on a plurality of pieces of slice data corresponding to a cross-section of each position of the three-dimensional object,
a transmittance with respect to a region for one layer formed in correspondence with one piece of slice data is greater than or equal to 20% in the black region, and
a transmittance of the black region in the normal direction is smaller than or equal to 10%.

10. The shaping device according to claim 1, wherein the black region is a region colored in piano black.

11. The shaping device according to claim 1, wherein the controller
causes the plurality of discharging heads to further form an interior region formed with a color having light absorbing property, the region configuring an interior of the three-dimensional object; and
form the black region and the coloring region on an outer side of the interior region.

12. A shaping device that shapes a three-dimensional object through a layering and shaping method based on a plurality of pieces of slice data corresponding to a cross-section of each position of the three-dimensional object, the shaping device comprising:
a plurality of discharging heads that each discharges a material of shaping; and
a controller that controls operation of the discharging head, wherein
the plurality of discharging heads include at least:
a black head that discharges a black material; and
the controller causes the plurality of discharging heads to form
a black region colored in black using at least the black material in at least one part of a portion where a hue is externally identifiable in the three-dimensional object,
a transmittance with respect to a region for one layer formed in correspondence with one piece of slice data is greater than or equal to 20% in the black region, and
a transmittance of the black region in the normal direction is smaller than or equal to 10%.

13. A shaping device that shapes a three-dimensional object, the shaping device comprising:
a plurality of discharging heads that each discharges a material of shaping; and
a controller that controls operations of the discharging heads; wherein
the plurality of discharging heads include at least:
a light absorbing material head that discharges a material having light absorbing property; and
a coloring material head that discharges a material for coloring of a chromatic color,
the controller causes the plurality of discharging heads to
form a coloring region colored using at least the material for coloring, and
a light absorbing region colored to a color having light absorbing property using at least the material having light absorbing property in at least one part of a portion where a hue is externally identifiable in the three-dimensional object, and
form the light absorbing region to be thicker than the coloring region with respect to a thickness in a normal direction perpendicular to a surface of the three-dimensional object.

14. A shaping device that shapes a three-dimensional object, the shaping device comprising:
a plurality of discharging heads that each discharges a material of shaping; and
a controller that controls operation of the discharging head; wherein
the plurality of discharging heads include at least:
a black head that discharges a black material; and
a coloring material head that discharges a material for coloring of a chromatic color,
the controller causes the plurality of discharging heads to form
a coloring region colored using at least the material for coloring;
a black region colored in black using at least the black material; and
an interior region formed with a color having light absorbing property, the region configuring an interior of the three-dimensional object, and
form the black region and the coloring region on an outer side of the three-dimensional object with respect to the interior region.

15. A shaping method for shaping a three-dimensional object, at least a black head that discharges a black material, and a coloring material head that discharges a material for coloring of a chromatic color being used for a plurality of discharging heads that each discharges a material of shaping; the method comprising:
causing the plurality of discharging heads to form
a coloring region colored using at least the material for coloring; and
a black region colored in black using at least the black material
in at least one part of a portion where a hue is externally identifiable in the three-dimensional object, and
form the black region thicker than the coloring region with respect to a thickness in a normal direction perpendicular to a surface of the three-dimensional object.

16. A shaping method for shaping a three-dimensional object through a layering and shaping method based on a plurality of pieces of slice data corresponding to a cross-section of each position of the three-dimensional object, a black head that discharges a black material being at least used for a plurality of discharging heads that each discharges a material of shaping; the method comprising causing the plurality of discharging heads to form a black region colored in black using at least the black material in at least one part of a portion where a hue is externally identifiable in the three-dimensional object; wherein
a transmittance with respect to a region for one layer formed in correspondence with one piece of slice data is greater than or equal to 20% in the black region; and
a transmittance of the black region in the normal direction is smaller than or equal to 10%.

17. A shaping method for shaping a three-dimensional object, at least a light absorbing material head that discharges a material having light absorbing property, and a coloring material head that discharges a material for coloring of a chromatic color being used for a plurality of discharging heads that each discharges a material of shaping; the method comprising causing
the plurality of discharging heads to form
a coloring region colored using at least the material for coloring, and
a light absorbing region colored to a color having light absorbing property using at least the material having light absorbing property in at least one part of a portion where a hue is externally identifiable in the three-dimensional object; and
form the light absorbing region to be thicker than the coloring region with respect to a thickness in a nonnal direction perpendicular to a surface of the three-dimensional object.

18. A shaping method for shaping a three-dimensional object, at least a black head that discharges a black material, and a coloring material head that discharges a material for coloring of a chromatic color being used for a plurality of discharging heads that each discharges a material of shaping; the method comprising causing the plurality of discharging heads to form
a coloring region colored using at least the material for coloring;
a black region colored in black using at least the black material; and
an interior region formed with a color having light absorbing property, the region configuring an interior of the three-dimensional object, and
form the black region and the coloring region on an outer side of the three-dimensional object with respect to the interior region.
